(19) United States
(12) Patent Application Publication
(10) Pub. No.: US 2005/0167530 A1
(43) Pub. Date: Aug. 4, 2005

(54) Mechanically sealed adjustable gas nozzle

(76) Inventors: Kenneth Ray Ward, Mansfield, OH (US); Otto W. Swogger, Mansfield, OH (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 10/768,263

(22) Filed: Jan. 30, 2004

(51) Int. Cl. B05B 1/26

(52) U.S. Cl. 239/515

(57) ABSTRACT

An adjustable gas nozzle has a nozzle body including a passageway therethrough opening into a first orifice at one end and an internal sealing surface adjacent thereto. A threaded internal surface is formed at a second end of the nozzle body. A conduit connected to a source of gas at one end having external threads adjacent a second end is threadably receivable within the second end of the nozzle body and is moveable between the first and second alternative positions relative to the nozzle body. Integral radial ribs are formed externally about the conduit between the external threads and the second end of the conduit and are engageable with the internal surface of said nozzle body between the sealing surface and the threads. The radial ribs on the exterior of the conduit have a larger diameter than the internal diameter of the interior wall of the nozzle body and is of a harder material so that deformation occurs in the wall resulting in a tight seal when the nozzle and the conduit are coupled. A flow adjusting member is supported within the conduit and is moveable toward and away from the orifice of the nozzle body as the nozzle body is threadably moved about the conduit. The adjustment member has an interior passageway which communicates the conduit with the orifice of the nozzle body and has an external surface for cooperatively engaging the sealing surface of the nozzle body in one alternative position and is spaced therefrom in a second alternative position. The flow of gas through the nozzle body orifice varies depending upon which alternative position is selected.

### BACKGROUND OF THE INVENTION

This invention relates to a nozzle for gas-heated appliances and more particularly, to a nozzle which may be used with appliances that burn natural gas or liquefied petroleum (LP) gas and which may be used in very high temperature burning environments as well as in lower conventional lower temperature environments. For example, the gas in appliances such as gas water heaters, gas furnaces, gas ovens and gas clothes dryers operate at conventional burning temperatures in the order of approximately 500 degrees to 550 degrees Fahrenheit while the temperature in the cleaning cycle of self-cleaning ovens may be in the order of approximately 900 degrees Fahrenheit. In these high temperature environments, it is important that the seals in the nozzles used to dispense the gas into the combustion chamber of the appliance do not fail or distort so as to prevent the gas from bleeding back and thereafter being drawn into the flame at rates above that desirable or building up potentially to cause an explosive environment.

The present invention is an improvement over the nozzle construction illustrated in U.S. Pat. No. 5,025,990 which is assigned to the common assignee of the present invention. In the nozzle of the aforesaid patent, although not illustrated, there traditionally may be an O-ring or may be a grease or wax seal between the nozzle body and the threaded conduit which supports and positions the insert to permit the outlet orifice to be either restricted for use with LP gas or unrestricted for use with natural gas. These seals under the high temperature conditions in a self-cleaning oven cycle may be subject to problems such as heretofore described.

### SUMMARY OF THE INVENTION

Consequently, it is a primary object of the present invention to provide a mechanical seal between the nozzle body and the adjustable gas nozzle and a conduit which couples to the nozzle body and supports a flow adjustment member, the seal being downstream of the location where the conduit couples to the nozzle body.

It is another object of the present invention to provide a mechanical seal between the nozzle body of an adjustable gas nozzle and a conduit which is threadably coupled to the nozzle body and supports a flow adjustment member, the seal comprising at least one radial ring on the conduit contacting and sealing against a smooth bore inner diameter of the nozzle body.

It is a further object of the present invention to provide an adjustable gas nozzle having a flow adjusting member positioned within a nozzle body supported on a conduit about which the nozzle body is threadably received, the adjusting member being moveable alternatively into or out of engagement with an interior wall of the nozzle body and having a configuration that permits gas to flow within a hollow therein and to the outlet orifice of the nozzle body at a first flow rate when it is in engagement with the interior of the nozzle body and to provide a flow path about the adjusting member for the gas to flow thereby to provide additional gas to flow through the outlet orifice of the nozzle body when out of engagement with the interior of the nozzle body.

Accordingly, the present invention provides an adjustable gas nozzle having a nozzle body including a passageway therethrough opening into a first orifice at one end and an internal sealing surface adjacent thereto, a threaded internal surface at a second end, a conduit connected to a source of gas at one end and having external threads adjacent a second end threadably receivable within said second end of the nozzle body and moveable between first and second alternative positions relative to said nozzle body, integral radial ribs disposed externally about the conduit intermediate the external threads and the second end of the conduit and engageable with the internal surface of said nozzle body intermediate said sealing surface and said threads, and a flow adjusting member supported within said conduit and moveable toward and away from said first orifice as the nozzle body is threadably moved about said conduit, the adjustment member having an interior passageway communicating the conduit with the first orifice and having an external surface for cooperatively engaging said sealing surface of the nozzle body in one alternative position and spaced therefrom in a second alternative position, the flow of gas through said first orifice varying dependent upon which alternative position is selected.

The radial ribs on the exterior of the conduit have a larger diameter than the internal diameter of the engageable interior surface of the nozzle body so that deformation occurs therebetween resulting in a tight seal when the nozzle and the conduit are coupled. Preferably the material of the conduit is harder than the nozzle so that the ribs deform the wall of the nozzle.

The flow adjusting member comprises an insert or body member having an orifice at an end thereof for communicating the flow of gas to the first orifice, the orifice in the adjusting member being smaller and thus more restrictive than the first orifice so that the gas flow rate is determined by the more restrictive orifice when the exterior surface of the adjusting member engages the sealing surface of the nozzle body. The adjusting member has a plurality of spaced apart elongated legs extending from a portion of the exterior surface, the legs being positionable on an interior surface of the conduit, a path being provided for flow of gas over the exterior surface intermediate the legs which flow communicates with the first orifice when the adjusting member is disengaged from the sealing surface.

### BRIEF DESCRIPTION OF THE DRAWINGS

The particular features and advantages of the invention as well as other objects will become apparent from the following description taken in connection with the accompanying drawings in which:

FIG. 1 is a longitudinal sectional view of an adjustable gas nozzle constructed in accordance with the present invention; and

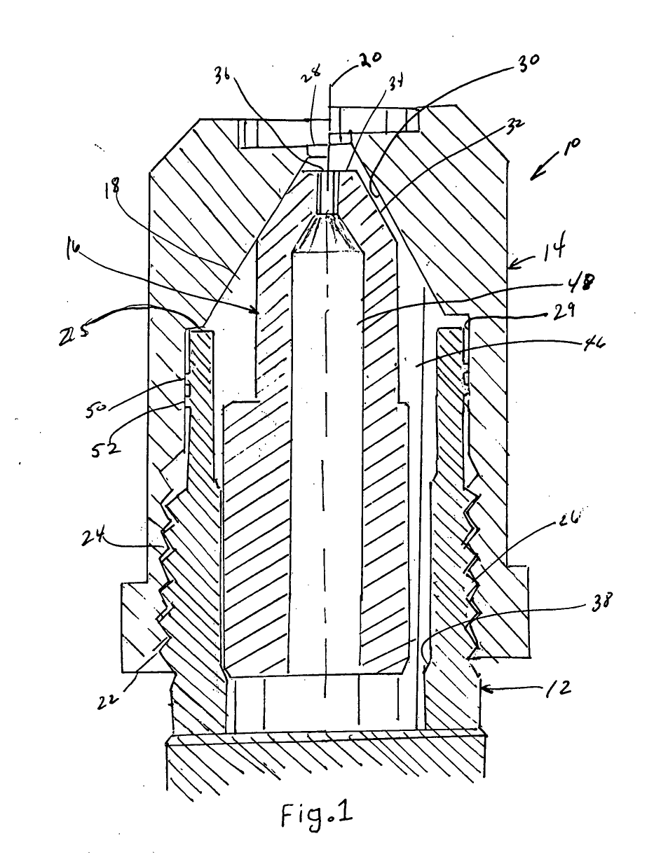

FIG. 2 is a partly exploded perspective thereof with the nozzle body removed from the conduit.

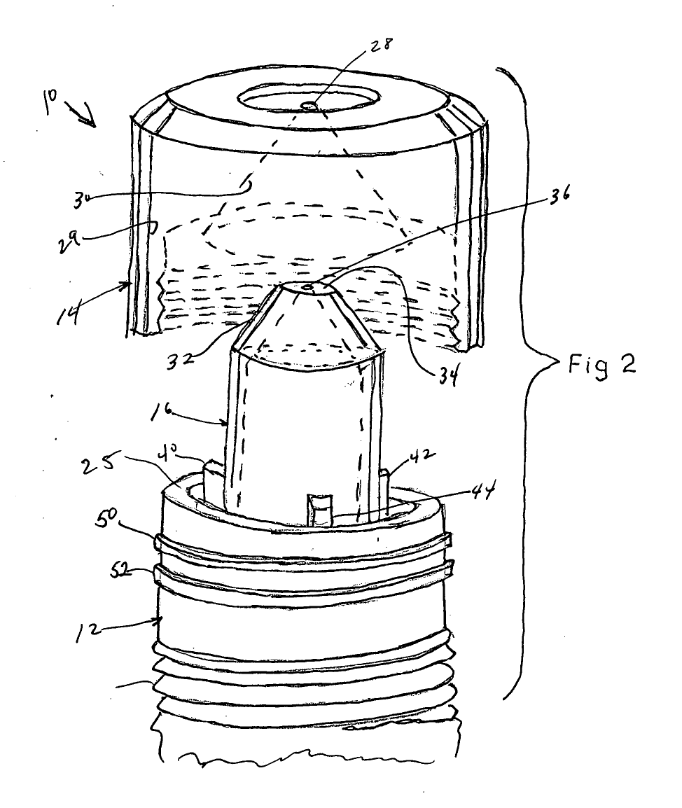

### DESCRIPTION OF THE PREFERRED EMBODIMENT

The adjustable gas nozzle 10 illustrated in the drawings comprises three main elements: a conduit 12 for receiving gas from a source (not illustrated), a nozzle member 14 for supplying a jet of the gas to the burner section of an appliance (not illustrated), and a flow adjusting member 16.

The nozzle member 14 has a gas passageway 18 which is coaxial therethrough about a longitudinal axis 20 with a threaded inlet opening at a first end 22. The threads 24 on the nozzle body member 14 coact with threads 26 adjacent the open end 25 thereof on the exterior surface of the conduit 12 which is coaxial with the axis of the nozzle body member. A second end of the nozzle body member has a coaxial outlet 28 and the nozzle body member effectively is an annular member having an inner circular surface 29, part of which is a conical surface 30 defining part of the passageway through the nozzle.

The flow adjusting member 16 has a longitudinal passageway therethrough coaxial with the axis 20 of the conduit and the nozzle body member. The flow adjusting member 16 is an insert that has an external circular surface 32 which is also conical at the same angle as the conical surface 30 of the nozzle body member. The internal conical surface 30 of the nozzle body member 14 is adapted to seal with the external conical surface 32 of the adjusting member when the nozzle body member is threaded onto the conduit 12, except that the tip end 34 does not make contact and thus will not crush inwardly to make the outlet 36 of the adjusting member more restricted. This outlet 36 of the adjusting member is a first restricted orifice and the outlet 28 of the nozzle body member is a second restricted orifice, the first restricted orifice 36 being smaller in diameter than the second restricted orifice 28 in the preferred embodiment.

A small shoulder 38 upset out of the inner wall of the conduit is adapted to support a plurality of elongated legs 40,42,44 integral with and projecting out of the exterior wall of the adjusting member 16 at the end of the adjusting member remote from the outlet to limit the position of the adjusting member 16 when the surfaces 30 and 32 are in sealing engagement. Preferably, as in the preferred embodiment, there are three such legs and the space between each such pair of legs provides a flow path 46 for gas to flow from the conduit toward the nozzle body member 14 thereby to provide a by-pass about the central flow path 48 in the adjusting member in the space at the interior of the conduit and the nozzle body member. Thus, when the nozzle body member 14 is threaded onto the conduit 12 tightly, the exterior conical surface 32 of the adjusting member 16 engages the internal conical surface 30 of the nozzle body member and precludes flow through this by-pass passageway and all the gas flows out the orifice 36. However, if the nozzle body member is not tightly threaded onto the conduit so that the exterior conical surface 32 of the adjusting member does not tightly contact the interior conical surface 30 of the nozzle body member, gas passes through the by-pass passageway 46 and may flow through the orifice 28 in the nozzle body member. Gas also at this time passes through the central flow passageway 48 of the adjusting member and this restrictive flow together with the flow in the bypass passageway may flow through the larger orifice 28 in the nozzle body member. If the nozzle body member is tightly threaded onto the conduit so that the two conical surfaces 30,32 seal one against the other, all the flow through the nozzle orifice 28 results from the flow through the more restrictive orifice 36 in the adjusting member which is the case when LP gas is the source of combustion. When the gas flows through both the central bore 36 in the adjusting member and in the by-pass passageways 46 the adjustable nozzle may be used with natural gas.

Intermediate the open end 25 and the threads 26 of the conduit 12 of the adjacent interior wall 29 of the nozzle body member spaced intermediate the conical surface 30 and the first end 22 is a sealing means for precluding leakage of gas from the passageway 18 back between the nozzle body member and the conduit. In the prior art such sealing means was grease, wax or an O-ring. However, as aforesaid, when operating in a high temperature environment, these seals may fail thereby resulting in a blow-back of gas past the threads 24,26 and dispersing of the gas into the appliance combustion chamber resulting in higher temperatures therein or a possible build-up of an explosive environment.

Consequently, in accordance with the present invention, there is at least one, and preferably two, integral ribs or ridges 50,52 formed preferably on the exterior wall of the conduit 12 of a diameter such as to securely engage and seal with the interior wall 29 of the nozzle body member as the threads 24,26 couple. The material of one of the nozzle body member or the conduit is harder than the other and the fit is an interference fit so that the ribs 50,52 or the wall will deform as they engage. Preferably, the conduit is constructed from steel tubing or the nozzle body member is a softer brass alloy and therefore the wall 29 will form as a nozzle body member 14 is threaded onto the conduit 12. Of course, the nozzle body member may be made from a harder material than the conduit, and in that case, the ribs will deform. In this manner, a good seal is made between the nozzle body member and the conduit that is unaffected by the temperatures encountered in the environment of the gas appliance.

In the preferred embodiment, the adjusting member 16 is also formed from a brass alloy so that when the nozzle body member 14 is tightened onto the conduit 12, the conical surface 32 of the adjusting member will make a good seal against the conical wall 30 of the nozzle body member. As aforesaid, and as described in the aforesaid U.S. Pat. No. 5,025,990, when this occurs all the gas flows through the central passageway 48 of the adjusting member and through the more restricted orifice 36 out through the larger orifice 28. This is the position when LP gas is utilized in the appliance. When natural gas is utilized, the nozzle body member is more loosely threaded onto the conduit so that the surfaces 30 and 32 do not seal. In this case, gas not only flows through the passageway 48 but also through the passageway 46 so the orifice 28 receives a greater supply of gas to be sprayed into the combustion chamber of the appliance.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

1. An adjustable gas nozzle comprising, in combination:
a nozzle body member having an elongated passageway therethrough with an inlet opening at a first end and an outlet at a second end;
a conduit connected to the nozzle body member;
an adjustment member disposed intermediate the conduit and the nozzle body member and having a first restricted orifice;
a coupling between said conduit and said body member to permit first and second alternative positions therebetween;
a by-pass passageway around the adjusting member and said first restricted orifice;
cooperative surfaces in said first position to seal between said body member and said adjusting member to close off flow through said by-pass passageway to permit a first gas flow through the two outlets in series so that gas flow rate is regulated by said first restricted orifice;
cooperating means associated with said adjusting member and said conduit upstream of said cooperating surfaces for limiting the displacement of said nozzle body member relative to said conduit in said first position;
said nozzle body member being moveable into said second position relative to said conduit to relieve the seal between the said body member and said adjusting member to permit a second gas flow of an amount greater than said first gas flow through the combination of said first restricted orifice and said by-pass passageway; and
a seal provided between said conduit and said nozzle body member to preclude leakage of gas therebetween, said seal comprising integral surfaces on said nozzle body member and said conduit.

2. An adjustable gas nozzle as recited in claim 1, wherein said seal comprises ribs on said conduit.

3. An adjustable gas nozzle as recited in claim 1, wherein the material of one of said conduit and body member is harder than the other.

4. An adjustable gas nozzle as recited in claim 3, wherein said seal comprises ribs on said conduit.

5. An adjustable gas nozzle as recited in claim 4, wherein the material of the conduit and ribs is harder than the nozzle body member.

6. An adjustable gas nozzle as recited in claim 1, wherein said restricted orifices are coaxial, and said first restricted orifice is smaller than the outlet of said nozzle body member.

7. An adjustable gas nozzle as recited in claim 1, wherein said cooperating means includes an annular shoulder about an anterior wall of said conduit; and
a plurality of legs elongated longitudinally along the adjusting member spaced longitudinally from the outlet of said adjusting member and positionable on said annular shoulder, the space between adjacent legs providing the by-pass passageway for gas flow therebetween when said cooperative surfaces are not engaged.

8. An adjustable gas nozzle as recited in claim 7, wherein said seal comprises ribs on the conduit.

9. An adjustable gas nozzle as recited in claim 7, wherein the material of one of said conduit and body member is harder than the other.

10. An adjustable gas nozzle as recited in claim 9, wherein said seal comprises ribs on said conduit.

11. An adjustable gas nozzle as recited in claim 10, wherein the material of the conduit and ribs is harder than the nozzle body member.

12. An adjustable gas nozzle as recited in claim 6, wherein said cooperating means includes an annular shoulder about an anterior wall of said conduit; and
a plurality of legs elongated longitudinally along the adjusting member spaced longitudinally from the outlet of said adjusting member and positionable on said shoulder, the space between adjacent legs providing a passageway for gas flow therebetween when said cooperative surfaces are not engaged.

13. An adjustable gas nozzle as recited in claim 12, wherein said seal comprises ribs on the conduit.

14. An adjustable gas nozzle as recited in claim 13, wherein the material of one of said conduit and body member is harder than the other.

15. An adjustable gas nozzle as recited in claim 14, wherein said seal comprises ribs on said conduit.

16. An adjustable gas nozzle as recited in claim 15, wherein the material of the conduit and ribs is harder than the nozzle body member.
